(19) United States
(12) Patent Application Publication
(10) Pub. No.: US 2024/0164530 A1
(43) Pub. Date: May 23, 2024

(54) BACK SUPPORT DEVICE

(71) Applicant: Jeff Kennedy, Toney, AL (US)

(72) Inventor: Jeff Kennedy, Toney, AL (US)

(21) Appl. No.: 18/516,528

(22) Filed: Nov. 21, 2023

Related U.S. Application Data
(60) Provisional application No. 63/426,811, filed on Nov. 21, 2022.

(51) Int. Cl. A47C 7/42

(52) U.S. Cl. CPC A47C 7/425

(57) ABSTRACT

A back support device for back pain relief is disclosed. The device may include an elongated body, an attachment portion coupled to the elongated body and configured to attach the back support device to a chair, a first strap attached to the elongated body, the first strap configured to secure around a user under the user's arms, and a second strap attached to the elongated body, the second strap configured to secure around the user's torso.

### CROSS-REFERENCE TO RELATED APPLICATION

This application claims the benefit of U.S. Provisional Patent Application No. 63/426,811, filed on Nov. 21, 2022, which is incorporated herein by reference in its entirety.

### TECHNICAL FIELD

The present disclosure generally relates to back support and relief devices. More particularly, the present disclosure pertains to a back support device that may be secured to the back of a chair or recliner to provide decompression of the spine while sitting or reclining.

### BACKGROUND

Back and spine pain has become increasingly common for most people in today's society. Back pain affects approximately tens of millions of people in the U.S. and is one of the leading causes of disability. From the typical office worker sitting at a desk for upwards of 6 hours each day to the construction worker, a vast many careers and hobbies contribute to back pain. Back pain is associated with reduced activities of daily living (e.g., walking, housework, personal care) and health-related quality of life. In addition, back pain is expensive to treat and often leads to missed workdays and reduced productivity, resulting in billions of dollars lost in the U.S. each year.

Spinal decompression therapy is utilized to treat various spinal ailments including herniated discs, degenerative disc disease, sciatica, posterior facet syndrome, and post surgical pain. Decompression therapy involves placing a patient's spine in a state of tension. The state of tension is created by an outside force such as a therapist or a mechanical process applying tension to the patient's spine. Then, the spine is held in a continuous state of tension. In some decompression therapy methods, spinal tension is maintained for periods that can be 30-minutes or longer.

As the spine is placed into a state of tension, the spinal vertebrae are separated allowing the intervertebral discs to realign into their proper positions. This action also allows herniated discs time to heal. In addition, nutrient-rich spinal (nucleus pulposa) fluid is drawn to the sites of tension due to the pressure drop created by the tensile forces.

Various forms of equipment and apparatuses have been proposed in the past to perform decompression therapy. Some equipment is relatively complicated and difficult to operate or require trained personnel to operate the same. There is, therefore, a need for a back support device that can be used by anyone, in the comfort of their own home, that does not require upper body strength or the use of the patient's arms and that can maintain the patient's body in the proper position for extended periods of time in order to effectively decompress the spine.

### SUMMARY

The present disclosure relates to a device that can be easily applied by anyone to a reclining chair in their home to provide spinal relief. Another object of the device is that a user can spend time each day, or multiple times a day, applying decompression therapy to their own spine.

In accordance with the illustrative embodiments of the present disclosure, there is provided a back support device that includes an elongated base having at least one strap and an attachment portion. The at least one strap may be configured to be attached to the torso of a user. The attachment portion may be a rounded segment on the top of the elongated base that is configured to secure the device to a headrest of a reclining chair.

In some embodiments, there is a first strap attached to the elongated base and a second strap attached near a lower end of the elongated base. The first strap may be adjusted to affix around a torso near the upper back or under the arms. The second strap may be adjusted to attached around a lower area of the torso, such as at the bottom of a user's rib cage. When the user reclines the reclining chair, the first strap will pull up while the second strap will hold a lower portion of the user's torso which decompresses the vertebrae of the spine between the first and second straps.

In another aspect of the device, the at least one straps may be movably attached to the elongated body so that a user can adjust which area of the spine to apply the decompression therapy.

Although the characteristic features of the exemplary embodiments will be particularly pointed out in the claims, the exemplary embodiments may be better understood after a review of the following description, taken in connection with the accompanying drawings wherein like numeral annotations are provided throughout.

### BRIEF DESCRIPTION OF DRAWINGS

FIG. 1 is a perspective view of the back support device according to an exemplary embodiment.

FIG. 2 is a perspective view of the back support device according to an exemplary embodiment attached to a reclining chair.

FIG. 3 illustrates the back support device according to an exemplary embodiment used on a person sitting in a reclining chair with the chair in a reclined position.

FIG. 4 is a perspective view of the back support device according to an exemplary embodiment.

### DETAILED DESCRIPTION OF EXEMPLARY EMBODIMENTS

Reference will now be made in detail to the following exemplary embodiments, which are illustrated in the accompanying drawings, wherein like reference numerals refer to like elements throughout. The exemplary embodiments may be embodied in various forms without being limited to the exemplary embodiments set forth herein. Descriptions of well-known parts are omitted for clarity.

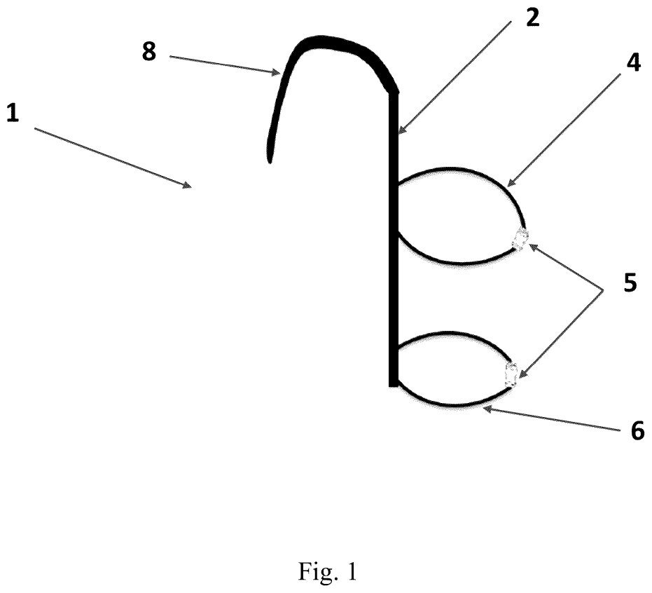

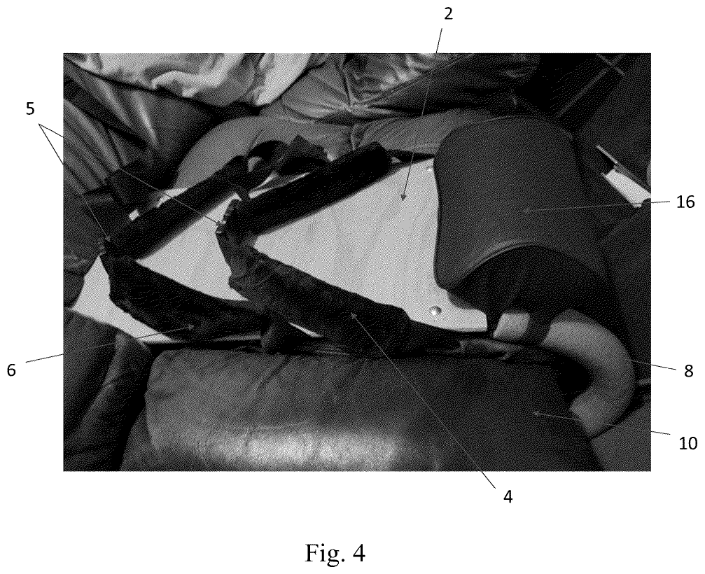

Referring now to FIGS. 1 and 4, a back support device according to one or more exemplary embodiments is shown. The back support device 1 may include an elongated body 2, a first strap 4, a second strap 6, and an attachment portion 8. The elongated body 2 may be constructed of a variety of rigid materials, such as metal, wood, polymer, or other suitable materials. The elongated body 2 may have a narrow width, such as shown in FIG. 1, or may have a greater width, as shown in FIG. 4. The first strap 4 is attached to the elongated body 2. The second strap 6 is attached to the elongated body 2 at a position below the first strap 4. The first and second straps 4, 6 may be coupled to the elongated body 2 via various mechanisms, such as adhesives, mechanical fasteners such as screws bolts, etc., or other types of coupling mechanisms. In one or more exemplary embodiments, the first and second straps 4/6 may be removably attached to the elongated body 2 so that the user may adjust the position to fit his or her body. The attachment portion 8 according to one or more exemplary embodiments is located at a top end of the elongated body 2 and may be configured to secure to a headrest of a chair or a reclining chair. In one exemplary embodiment, the attachment portion 8 is a curved or arching piece that is integrally part of the elongated body 2. In other embodiments, the attachment portion 8 may be removably attached from the elongated body 2.

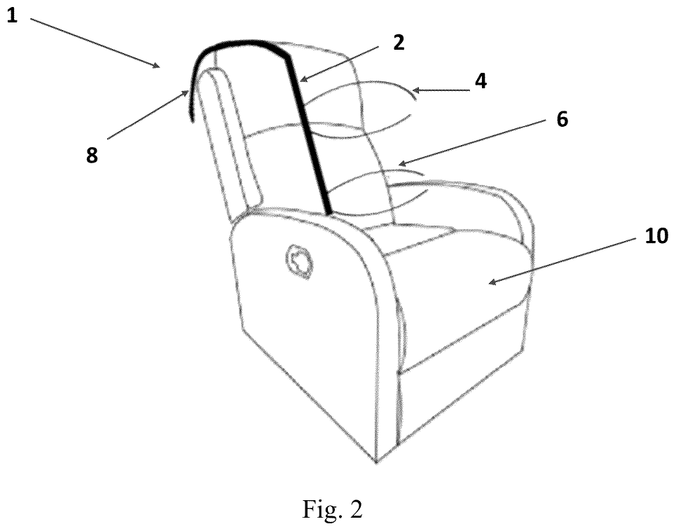

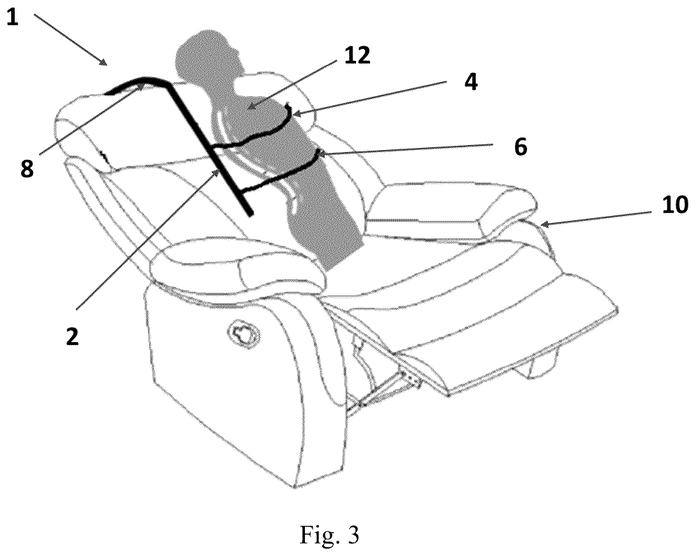

FIG. 2 shows the back support device 1 according to one or more exemplary embodiments on a reclining chair 10, and FIG. 3 shows the back support device 1 according to one or more exemplary embodiments on the reclining chair 10 with a human torso 12 illustrated to show proper use of the device. Referring to FIGS. 2 and 3, the elongated body 2 rests against the back of the chair 10. The attachment portion 8 is secured over the headrest of the chair 10. According to one or more exemplary embodiments the back support device 1 may include multiple attachment portions 8. For example, there may be two attachment portions 8 that are curved to fit over the top of the back of the chair 10. According to one or more exemplary embodiments, the one or more attachment portions may wrap laterally around the back of the chair 10, and/or hook onto the top of the back of the chair 10. In order to use the back support device according to one or more exemplary embodiments, a user sits in the chair 10, and the first strap 4 is secured to the user under the user's arms, and the second strap 6 is secured around the user's torso 12 lower down, for example near the bottom of the rib cage. The chair 10 is then reclined to decompress the spine 14 of the user 12. More specifically, normally when a user sits in a recliner chair, as the chair reclines, the user's torso remains in the same position as the back of the chair reclines, such that the user's torso slides with respect to the back of the chair. According to one or more exemplary embodiments, reclining the chair causes the first strap 4 and the second strap 6 to pull up on the user's upper torso 12 which would decompress the lumbar spine. In particular, the attachment portions 8 keep the back support device 1 in the same position on the chair 10 as the chair reclines. When the chair 10 reclines, the back support device 1 begins to slide in the upward direction relative to the user. The first strap 4 and the second strap 6 are secured to the elongated member 2, such that the upward movement of the back support device 1, including the elongated member 2, first strap 4, and second strap 6, pulls the user in the upward direction relative to the seat of the chair 10. The upward pulling of the first and second straps 4, 6, and the downward pull of the user's weight decompresses the lumbar spine.

FIG. 4 shows a back support device according to another example embodiment. Referring to FIG. 4, the back support device includes an elongated body 2, which as shown in FIG. 4 includes a substantially rectangular rigid component that may be made of wood, hard plastic, or any other suitable rigid material. The back support device may include one or more attachment portions 8, which may be sized and shaped to fit over the back of a reclining chair 10 (shown in the reclined position in FIG. 4). The first strap 4 is secured to the elongated body 2 at an upper portion of the elongated body 2, and the second strap 6 is secured to the elongated body 2 at a lower portion of the elongated body 2. The first and second straps 4, 6 include connecting mechanisms 5, which may be adjustable to ensure a close fit around the user. In the exemplary embodiment of FIG. 4, the connecting mechanisms are shown as clips, though other types of connecting mechanisms, such as hook and loop connectors, belt buckle-style connectors, seat belt connectors, etc., may be used. The back support device may also include a head support 16, which may be coupled to the elongated body 2 and/or the one or more attachment portions 8, and may support the user's head.

Although the inventive concepts of the present disclosure have been described and illustrated with respect to exemplary embodiments thereof, it is not limited to the exemplary embodiments disclosed herein and modifications may be made therein without departing from the scope of the inventive concepts.

What is claimed is:

1. A back support device, the back support device comprising:
an elongated body;
an attachment portion coupled to the elongated body and configured to attach the back support device to a chair;
a first strap attached to the elongated body, the first strap configured to secure around a user under the user's arms; and
a second strap attached to the elongated body, the second strap configured to secure around the user's torso.

2. The back support device of claim 1, wherein the first and second straps include respective first and second coupling mechanisms configured to secure the user to the elongated body.

3. The back support device of claim 1, wherein the attachment portion is shaped to fit over a top of the chair.

4. The back support device of claim 3, comprising a headrest coupled to the elongated body or the attachment portion.

5. The back support device of claim 1, wherein the elongated member has an approximately rectangular shape.

6. The back support device of claim 1, wherein at least one of the first strap and the second strap are removably attached to the elongated member.

7. The back support device of claim 1, wherein at least one of the first strap and the second strap are adjustable relative to the elongated member.

8. The back support device of claim 1, wherein the attachment portion comprises a first attachment portion and a second attachment portion configured to attach to a top of a back of the chair.
